(19) United States
(12) Patent Application Publication
(10) Pub. No.: US 2026/0075694 A1
(43) Pub. Date: Mar. 12, 2026

(54) LOW-POWER LED LIGHT STRING CONTROL SYSTEM AND METHOD

(71) Applicant: Shenzhen HSG Electronics Co., LTD, Shenzhen (CN)

(72) Inventors: WEI SHEN, Shenzhen (CN); BO GUAN, Shenzhen (CN); ZONGZE YE, Shenzhen (CN)

(21) Appl. No.: 18/896,408

(22) Filed: Sep. 25, 2024

(30) Foreign Application Priority Data
Sep. 10, 2024 (CN) 202411261505.3

(51) Int. Cl. H05B 47/175

(52) U.S. Cl. CPC H05B 47/198

(57) ABSTRACT

Disclosed are a low-power LED light string control system and method, the system includes a controller and LED lamp bead chips that are connected to the controller, each of the LED lamp bead chips further includes an address code module, a data module, and a drive module, where the address code module and the drive mode are both electrically connected to the data module; and the address code module is set to a non-sleep state and is capable of always making comparison with control data sent by the controller.

### CROSS-REFERENCE TO RELATED APPLICATIONS

This application claims priority to Chinese Patent Application No. 202411261505.3, filed on Sep. 10, 2024, which is hereby incorporated by reference in its entirety.

### TECHNICAL FIELD

The present disclosure relates to LED light string light sources, and more particularly relates to a low-power LED light string control system and method.

### BACKGROUND

With the advancement of optoelectronic technology and information technology, a light-emitting diode (LED) lamp is widely used in various indoor and outdoor media due to its rich colors and content display. An LED lamp bead contains a drive circuit inside, addresses can be stored within the drive circuit, a controller addresses each LED lamp bead separately to achieve on/off control or color control of the LED lamp bead, such that an entire LED glass screen can display images identified by the controller, exhibiting richness, appeal, and entertainment value of display effects.

In order to achieve different brightness or colors at each lamp point of an LED light string based on parallel data lines, it is necessary to assign a unique address for each lamp point in advance. Existing LED lamp bead chips that are usually used as a parallel structure need to be powered on in the absence of signal control, which undoubtedly increases power consumption of the LED lamp bead chips in a standby state. For the problem of great power consumption by the LED light string and lower refresh rate caused by data transmission delay in the prior art, no effective solutions are available at present.

### SUMMARY

In view of the deficiencies in the prior art, the present disclosure provides a low-power LED light string control system and method, so as to solve the problems that great power consumption by the LED and lower refresh rate caused by data transmission delay in the display process of the LED light string in the prior art.

In a first aspect, the present disclosure provides a low-power LED light string control system, the system includes a controller and LED lamp bead chips connected to the controller, each of the LED lamp bead chips further includes an address code module, a data module, and a drive module, where the address code module and the drive mode are both electrically connected to the data module;
the address code module is set to a non-sleep state and is capable of always making comparison with control data sent by the controller, and specifically, the address code module compares a lamp bead address contained in the received control data with lamp bead addresses stored in the address code module, and then transmits the control data to the data module when the lamp bead address matches one of the lamp bead addresses stored in the address code module;
the data module processes the received control data to generate control signals; and
the drive module controls an operating state of the corresponding LED lamp bead based on the control signals generated by the data module.

Further, the controller is configured to send the control data to the LED lamp bead chips in real time, where the control data includes the lamp bead address and lamp status control data.

Further, when the lamp bead address fails to match one of the lamp bead addresses stored in the address code module, the corresponding LED lamp bead of the LED lamp bead chip remains unchanged in a current state.

Further, the LED light string is composed of a plurality of LED lamp points, and each of the LED lamp points includes the LED lamp bead chip and at least one of the LED lamp beads that emits light in response to drive current from the LED lamp bead chip.

Further, when the LED lamp bead chips are in a sleep state, only the address code module is in a real-time standby state.

Further, the address code module stores the lamp bead addresses of all of the LED lamp beads on the entire LED light string, and the lamp bead addresses are pre-programmed into the address code module.

Further, each of the LED lamp beads is an RGB tri-color lamp bead with 3 channels, each of the channels occupies 16 data bits, and a data structure of the lamp bead address occupies 48 data bits.

Further, a method for controlling the LED light string includes a synchronized lamp on/off command, a designated address lamp on/off command, and a designated random code lamp on/off command; and all of the commands contain data bits.

In a second aspect, the present disclosure further provides a low-power LED light string control method, which can be applied to the LED light string control system, and the method includes:
S110, when the installed LED light string is powered on, the controller sends a control signal to the address code module of the LED lamp bead chips;
S120, the address code module compares a lamp bead address contained in the received control data with lamp bead addresses stored in the address code module, and then transmits the control data to the data module when the lamp bead address matches one of the lamp bead addresses stored in the address code module
S130, the data module processes the received control data to generate control signals; and
S140, the drive module controls an operating state of the corresponding LED lamp bead based on the control signals generated by the data module.

The LED lamp bead chip of the present disclosure is provided with a normal non-sleeping address code module, which can always making comparison with control data sent by the controller; when the LED lamp bead address code matches, the data module is awakened to receive 48 bits of data, such that the problem of high power consumption caused by the LED lamp bead chip sending codes without lighting up the lamp bead is solved, and the problem of low refresh rates caused by data transmission delay is also solved.

### BRIEF DESCRIPTION OF DRAWINGS

FIG. 1 is a structural schematic diagram of a principle of a low-power LED light string control system according to an embodiment of the present disclosure.

FIG. 2 is a structural schematic diagram of a principle of an LED lamp bead chip of a low-power LED light string according to an embodiment of the present disclosure.

FIG. 3 is a schematic flow chart of a low-power LED light string control method according to an embodiment of the present disclosure.

### DESCRIPTION OF EMBODIMENTS

In order to make the objectives, technical solutions and advantages of the present disclosure clearer, the present disclosure will be further described in detail below in conjunction with the drawings and embodiments. It should be understood that specific embodiments described herein are merely used to explain the present disclosure, and are not used to limit the present disclosure. In addition, the technical features involved in each implementation of the present disclosure described below may be combined with one another as long as they do not constitute a conflict with one another.

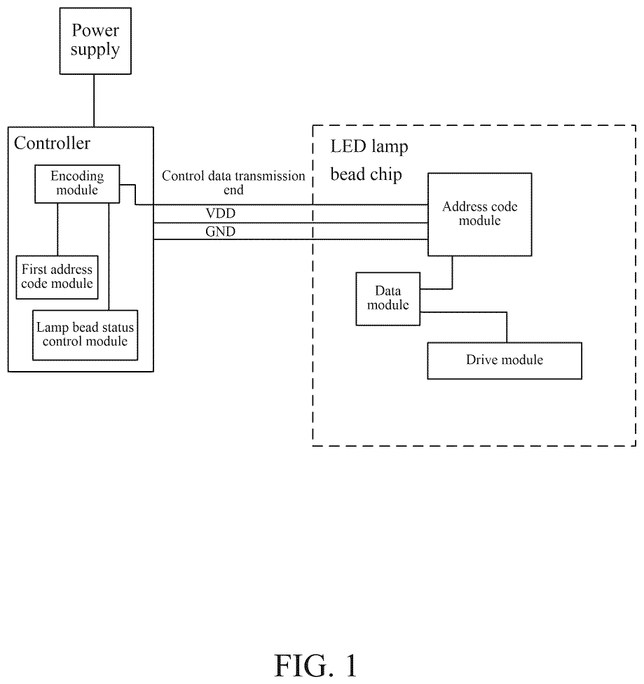

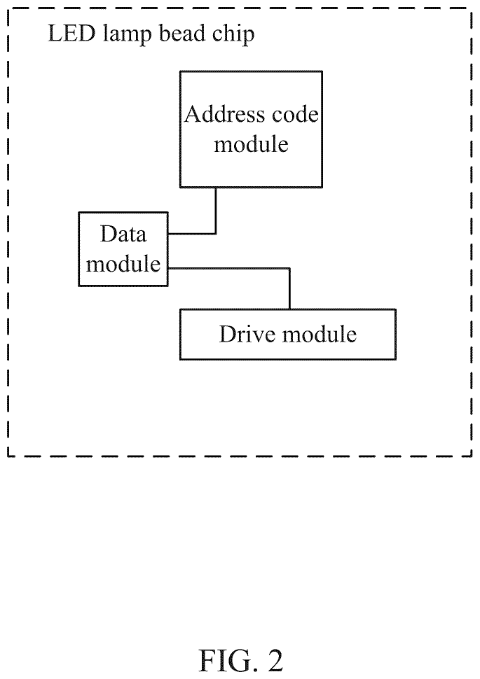

This embodiment discloses a control system for an LED light string based on parallel data lines, as shown in FIGS. 1-2, the system includes a controller and LED lamp bead chips, where the controller and the LED lamp bead chips are connected to an external power supply (VDD) and a ground (GND).

In a specific embodiment, the LED light string is connected to the controller via the parallel data lines, and the controller is connected to the external power supply, where the parallel data lines are single lines or a single group of differential data lines, the parallel single lines or the single group of differential data lines connect the LED lamp bead chips of all LED lamp points to the controller. Specifically, when in use, the controller sends a control command frame (also known as control data) based on a single-line edge self-aligned encoding protocol, and a LED lamp bead chip of each of the LED lamp points receives the control data.

In a specific embodiment, each of the LED lamp bead chips further includes an address code module, a data module, and the drive module, where the address code module and the drive mode are both electrically connected to the data module; the address code module is set to a non-sleep state; the address code module is configured to receive address codes sent by the controller, verify the uniqueness of a matching address code, and power on the data module and the drive module; the data module is configured to receive lamp bead status control data sent by the controller, and process the control data to obtain control signals; and the drive module is configured to control an operating state of the corresponding LED lamp bead based on the control signals received and processed by the data module, and specifically, the drive module drives the corresponding LED lamp bead to emit light based on the drive current generated by the control signals.

The controller further includes an encoding module, a first address code module, and a lamp bead status control module, where the encoding module is connected to both the first address code module and the lamp bead status control module. In this embodiment, the controller is configured to send the control data to the LED lamp bead chips in real time, where the control data is the lamp bead address and lamp status control data. The LED light string is composed of a plurality of LED lamp points. Each of the LED lamp points includes the LED lamp bead chip and at least one of the LED lamp beads that emits light in response to drive current from the LED lamp bead chip.

LED lamps are generally composed of lamp beads in three colors, that is, red (R), green (G), and blue (B), or in four colors, that is, red (R), green (G), blue (B), and white (W). According to a principle of three primary colors, superposition of the three primary colors of red (R), green (G), and blue (B) can produce a variety of colors, and RGB three-color lamp beads or RGBW four-color lamp beads in the prior art are based on the principle. In some application scenarios, each group of the LED lamp points includes LED lamp beads consisting of red, green, and blue and one of the LED lamp bead chip, or includes LED lamp beads consisting of red, green, blue, and white and one of the LED lamp bead chips. All of the LED lamp beads are connected in parallel through the corresponding LED lamp bead chips between a power supply end and a ground end of a power supply line, and signal receiving ends of the LED lamp bead chips in each group are connected in parallel to a control line of the controller through wires.

Each of the LED lamp points contains the LED lamp bead chip. In the present disclosure, the LED lamp bead chips need to be burned into the address code before being assembled into the LED light string to facilitate the identification of the LED lamp bead chips and control of RGB colors, brightness, pattern modes, and the like. In the present disclosure, the address code module is arranged inside the corresponding LED lamp bead chip and is set to the non-sleep state, such that comparison can be continuously performed with the control data from the controller. The address code module stores the lamp bead addresses of all of the LED lamp beads on the entire LED light string, and the lamp bead addresses are pre-programmed into the address code module, the address code module compares a lamp bead address contained in the received control data with lamp bead addresses stored in the address code module, and then transmits the control data to the data module when the lamp bead address matches one of the lamp bead addresses stored in the address code module. The data module processes the received control data to generate control signals. S140, the drive module controls an operating state of the corresponding LED lamp bead based on the control signals generated by the data module, and the corresponding lamp bead on the LED light string will be lighted on or off, or other controls will be performed; when the lamp bead address fails to match one of the lamp bead addresses stored in the address code module, the corresponding LED lamp bead of the LED lamp bead chip remains unchanged in a current state.

Under normal circumstances, when the LED lamp bead chips are in a sleep state, only the address code module is in a real-time standby state.

In the present disclosure, a data structure of the control signal is: Trst+a first chip Adij+48 bits of data+a second chip Adij+48 bits of data+ . . . +an Nth chip Adij+48 bits of data+Gain data+Trst.

In the present disclosure, address code data is named Adij, and the data structure of the address code is as follows:

| 47 | 46 | 45 | . . . | 34 | 33 | 32 | 31 | 30 | 29 | 28 | . . . | 18 | 17 | 16 | 15 | 14 | 13 | . . . | 2 | 1 | 0 |
|---|---|---|---|---|---|---|---|---|---|---|---|---|---|---|---|---|---|---|---|---|---|
| R15 | R14 | R13 | . . . | R2 | R1 | R0 | G15 | G14 | G5 | G13 | . . . | G2 | G1 | G0 | B15 | B14 | B13 | . . . | B2 | B1 | B0 |

The table above itemizes the data structure of the addresses of the LED lamp beads, where each of the LED lamp beads is an RGB tri-color lamp bead with 3 channels. It should be noted that each of the channels in the foregoing RGB 3-channel data or RGBW 4-channel data occupies 16 bits of control data. The RGB 3-channel data contains a total of 48 bits of control data.

TABLE 2
15-bit gain data format

| 14 | 13 | 12 | 11 | 10 | 9 | 8 | 7 | 6 | 5 | 4 | 3 | 2 | 1 | 0 |
|---|---|---|---|---|---|---|---|---|---|---|---|---|---|---|
| R4 | R3 | R2 | R1 | R0 | G4 | G3 | G2 | G1 | G0 | B4 | B3 | B2 | B1 | B0 |

A method of controlling the LED light string, for example, includes a synchronized lamp on/off command, a designated address lamp on/off command, and a designated random code lamp on/off command; and all of the commands contain data bits, and each of the data bits consist of RGB 3-channel data or RGBW 4-channel data.

In a further embodiment, the synchronized lamp on/off command is sent to each of the LED lamp beads of the LED light string, which can achieve synchronized on/off. In this embodiment, the synchronized lamp on/off control command is composed of a synchronized lamp on/off command word and the data bits. Specifically, the synchronized lamp on/off command word is preferably 16 bits, where lower 5 bits are used to adjust a gain of the LED, and correspond to 32 adjustable gains. It should be noted that the data bits of gain data can be 15 bits. Depending on the application scenarios and functionality, the data bits of gain data can be 18 bits, 21 bits, or 24 bits, which are not limited herein.

When the data bits are the RGB 3-channel data, the synchronized lamp on/off control command has a total of 64 bits.

In a further technical solution of this embodiment, the designated address lamp on/off command is sent to each of the LED lamp beads of a group of the LED lamp beads, and the LED lamp beads of the designated address in the group of the LED lamp beads are then lighted on and off. In this embodiment, the designated address lamp on/off command consists of the designated address lamp on/off command word, a first configuration bit, an address bits, and the data bits. In this embodiment, the designated address lamp on/off command is preferably 8 bits, where lower 3 bits are used to adjust the gain of the LED, and correspond to 8 adjustable gains. In this embodiment, the first configuration bit and the address bits are both 8 bits, and 256 addresses are supported at most. The first configuration bit in this embodiment is an address enable bit, corresponding to an 8-bit address one by one. The method of controlling the LED light string in this embodiment includes precisely configured command logic, which can enables precise and efficient control of LED color, brightness, and pattern mode, thereby achieving the desired technical effects.

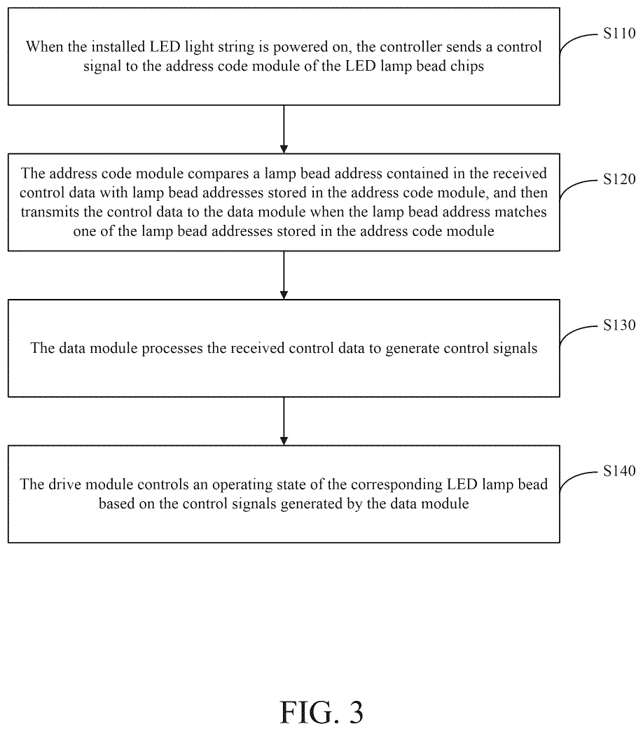

As shown in FIG. 3, the present disclosure further provides a low-power LED light string control method, which is applied to the LED light string control system, and the method includes:
S110, when the installed LED light string is powered on, the controller sends a control signal to the address code module of the LED lamp bead chips;
S120, the address code module compares a lamp bead address contained in the received control data with lamp bead addresses stored in the address code module, and then transmits the control data to the data module when the lamp bead address matches one of the lamp bead addresses stored in the address code module;
S130, the data module processes the received control data to generate control signals; and
S140, the drive module controls an operating state of the corresponding LED lamp bead based on the control signals generated by the data module.

It should be noted that the low-power LED light string control method can be applied to realize the LED light string control system, which will not be further elaborated herein.

The LED lamp bead chip of the present disclosure is provided with a normal non-sleeping address code module, which is always compared with the control data sent by the controller; when the LED lamp bead address code matches, the data module is awakened to receive 48 bits of data; and when the address code data does not match, the LED lamp bead corresponding to the LED lamp bead chip remains unchanged in the current state, such that the problem of high power consumption caused by the LED lamp bead chip sending codes without lighting up the lamp bead is solved, and the problem of low refresh rates caused by data transmission delay is also solved.

It is easy for those skilled in the art to understand that the above descriptions are merely preferred embodiments of the present disclosure, and are not intended to limit the present disclosure. Any modifications, equivalent replacements and improvements, etc. made within the spirit and principle of the present disclosure should fall within the scope of protection of the present disclosure.

What is claimed is:

1. A low-power LED light string control system, comprising a controller and LED lamp bead chips connected to the controller, each of the LED lamp bead chips further comprises an address code module, a data module, and a drive module, wherein the address code module and the drive mode are both electrically connected to the data module;
the address code module is set to a non-sleep state and is capable of always making comparison with control data sent by the controller; and the address code module compares a lamp bead address contained in the received control data with lamp bead addresses stored in the address code module, and then transmits the control data to the data module when the lamp bead address matches one of the lamp bead addresses stored in the address code module;
the data module processes the received control data to generate control signals; and
the drive module controls an operating state of the corresponding LED lamp bead based on the control signals generated by the data module.

2. The low-power LED light string control system according to claim 1, wherein
the controller is configured to send the control data to the LED lamp bead chips in real time, and the control data comprises the lamp bead address and lamp status control data.

3. The low-power LED light string control system according to claim 1, wherein
when the lamp bead address fails to match one of the lamp bead addresses stored in the address code module, the corresponding lamp bead of the LED lamp bead chips remains unchanged in a current state.

4. The low-power LED light string control system according to claim 3, wherein the LED light string is composed of a plurality of LED lamp points, and each of the LED lamp points comprises the LED lamp bead chip and at least one of the LED lamp beads that emits light in response to drive current from the LED lamp bead chips.

5. The low-power LED light string control system according to claim 1, wherein when the LED lamp bead chips are in a sleep state, only the address code module is in a real-time standby state.

6. The low-power LED light string control system according to claim 1, wherein the address code module stores the lamp bead addresses of all of the LED lamp beads on the entire LED light string, and the lamp bead addresses are pre-programmed into the address code module.

7. The low-power LED light string control system according to claim 1, wherein each of the LED lamp beads is an RGB tri-color lamp bead with 3 channels, each of the channels occupies 16 data bits, and a data structure of the lamp bead address occupies 48 data bits.

8. The low-power LED light string control system according to claim 7, wherein a method for controlling the LED light string comprises a synchronized lamp on/off command, a designated address lamp on/off command, and a designated random code lamp on/off command; and all of the commands contain data bits.

9. A low-power LED light string control method applied to the LED light string control system according to claim 1, comprising:
S110, when the installed LED light string is powered on, the controller sends a control signal to the address code module of the LED lamp bead chips;
S120, the address code module compares a lamp bead address contained in the received control data with lamp bead addresses stored in the address code module, and then transmits the control data to the data module when the lamp bead address matches one of the lamp bead addresses stored in the address code module;
S130, the data module processes the received control data to generate control signals; and
S140, the drive module controls an operating state of the corresponding LED lamp bead based on the control signals generated by the data module.
